(19) United States
(12) Patent Application Publication
(10) Pub. No.: US 2011/0018216 A1
(43) Pub. Date: Jan. 27, 2011

(54) Base structure of baby walker

(76) Inventor: Chung-Jen Cheng, Sigang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,740

(22) Filed: Jul. 22, 2009

(51) Int. Cl. B62B 7/00

(52) U.S. Cl. 280/87.051

(57) ABSTRACT

This invention relates to base structure of baby walker which essentially has a base body in C shape, both sides of which are provided with guiding grooves opposite to each other. Rails are formed respectively on both sides at the front ends of the guiding grooves, and openings are respectively formed on both sides at the front ends of the rails. A pivot mount portion is provided on rear end of each guiding groove. A foldable leg unit is provided on the base body, which has two support rods pivotably connected in crossover shape, a cylindrical combining part is provided outwardly on both sides at the bottom end of each support rod. The combining part of the rear support rod is mounted on the pivot mount portion, while the combining part of the front support rod is mounted on the rail through the opening so as to slide thereon. Excellent stability can be achieved when the combining parts of the support rods slide along the rails.

### BACKGROUND OF THE INVENTION

1. Field of the invention

This invention relates to a base structure of baby walker, especially to a base structure of baby walker having excellent stability during the sliding of foldable leg unit.

2. Brief Description of the Prior Art

Referring to a conventional baby- walker disclosed in Taiwanese Patent Gazette No. M 342,812 entitled “Baby Walker as Walk-Helper”, in which it essentially comprises a main body in cooperation with a support frame and a seat frame, in which:

The main body has a mobile frame pivotally supported by foldable leg units which are supported on the upper end of a base. Guiding grooves opposite to each other are provided at both inner sides of the base. Each foldable leg unit has two rods connected in crossover shape in which the bottom end of one rod is located within the guiding groove to slide therein. The mobile frame has its rear side formed as an open-end the inner edge of which are provided with an abutting ridge. Interlinking slots opposite to each other are respectively provided at both sides of the mobile frame;

The support frame, corresponding to the mobile frame of the main body, also forms an open-end at its one end and has interlinking blocks, corresponding to the interlinking slots of the mobile frame, provided respectively on both sides;

The seat frame has a central cavity in its center for accommodation of seat padding. Corresponding to the abutting ridge of the mobile frame of the main body, an abutting recess is formed at the outer edge of the seat frame. A hook portion is provided at the rear end of the seat frame for engaging with the support frame.

Then, the mobile frame is assembled with the support frame and the seat frame to form a baby walker for ready use. On the other hand, if the seat frame is removed, the support frame can be combined with the mobile frame to form a walk-helper.

However, as the guiding grooves are disposed at the inner sides of the base, only one side of each rod of the foldable leg units is inserted in the guiding groove to conduct sliding. Thus, stability during the sliding of the rods is reduced, and then safety in use is also influenced.

### SUMMARY OF THE INVENTION

In view of the above disadvantages, the inventor of this invention has proposed a base structure of baby walker in which rails are formed on the top surface of a base body; combining parts are respectively provided on both sides of support rods of a foldable leg unit, which are then mounted on the rails. In this manner, excellent stability can be achieved when the combining parts of the support rods slide along the rails. Furthermore, the foldable leg unit can be separated from the base body so as to reduce space for storage.

According to a preferred embodiment of the present invention, the base structure of baby walker is characterized in that it essentially comprises a base body in C shape, both sides of which are provided with guiding grooves opposite to each other; rails are formed respectively on both sides at the front ends of the guiding grooves, and openings are respectively formed on both sides at front ends of the rails; a pivot mount portion is provided on the rear end of each guiding groove; a foldable leg unit is provided on the base body, which has two support rods pivotably connected in crossover shape; a cylindrical combining part projects outwardly on both sides at the bottom end of each support rod, the combining part of the rear support rod being mounted on the pivot mount portion, while the combining part of the front support rod being mounted on the rail from the opening so as to slide therein; cover bodies of U-shape corresponding to the pivot mount portions and the openings being provided, detent hooks being provided on the bottom surface at both ends of the cover bodies so as to engage into the openings.

According to a preferred embodiment of the present invention, the top end of the foldable leg unit is fixed with a mobile frame, a seat or a seat frame depending on user's demand.

### BRIEF DESCRIPTION OF THE DRAWINGS

FIG. 1 is a perspective exploded view of the bottom part of the first embodiment of the present invention.

FIG. 2 is a perspective exploded view of the top part of the first embodiment of the present invention.

FIG. 3 is an assembled top view of the first embodiment of the present invention.

FIG. 4 is perspective assembled view showing the second embodiment of the present invention.

FIG. 5 is a perspective exploded view of the top part of the second embodiment of the present invention.

### DETAILED DESCRIPTION OF PREFERRED EMBODIMENTS

The technical content, objects and effectiveness of the present invention will become more apparent by the detailed description of preferred embodiments of the present invention in conjunction with the accompanying drawings.

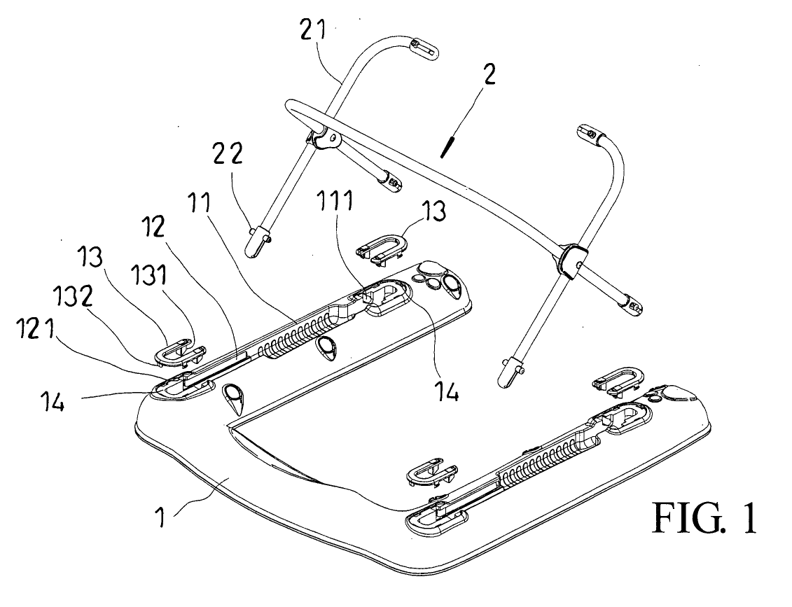

FIG. 1 is a schematic view showing the first embodiment of a base structure of baby walker of the present invention, which comprises a base body (1) and a foldable leg unit (2), as shown in the figure.

The base body (1) is formed as C shape, both sides of which are provided with guiding grooves (11) opposite to each other. Rails (12) are formed respectively on both sides at front ends of the guiding grooves (11) for mounting the combining parts (22) of the foldable leg unit (2) thereon, and openings (121) are respectively formed on both sides at front ends of the rail (12) such that the combining parts (22) are able to be mounted onto the rails (12) therefrom; cover bodies (13) of U-shape corresponding to the openings (121) of the rails (12) are respectively provided to be fixed over the openings (121), detent hooks (131) being provided on the bottom surface at both ends of each cover body (13) so as to engage into the opening (121); a plurality of snap hooks (132) being provided along the bottom surface of each cover body (13), and correspondingly a plurality of snap holes (14) being disposed at the front end of each rail (12) for interlocking with said plural snap hooks (132); a pivot mount portion (111) being provided on the rear end of each guiding groove (11) for pivotal connection with the combining part (22); cover bodies (13) and snap holes (14) being also provided at the pivot mount portions (111).

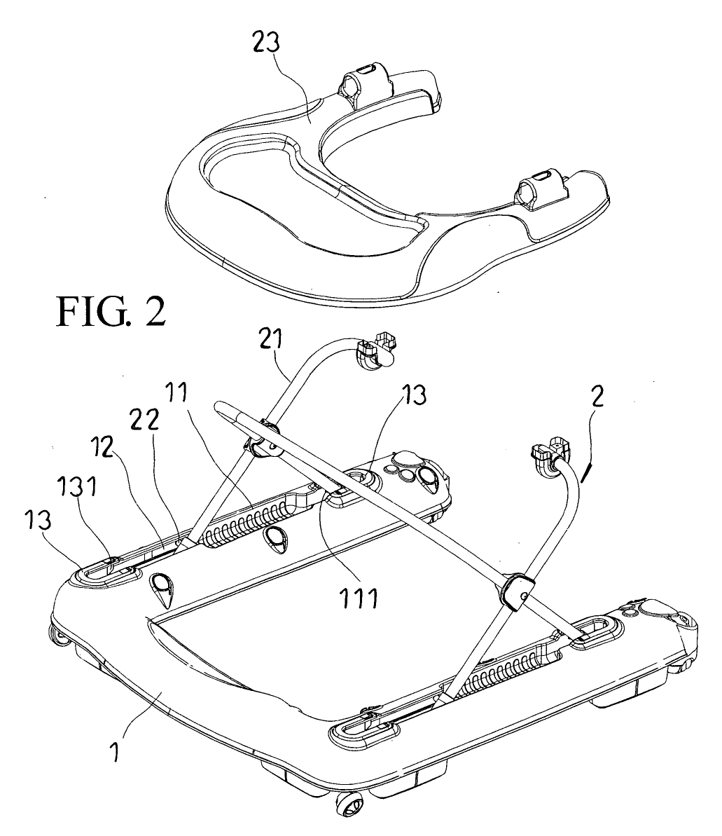

A foldable leg unit (2) has two support rods (21) pivotably connected in crossover shape. A cylindrical combining part (22) projecting outwardly on both sides is provided at the bottom end of each support rod, which is mounted on each rail (12) of the base body (1) for sliding thereon. Referring to FIG. 2, a mobile frame (23) is fixed horizontally on the top end of the foldable leg unit (2) to serve as an walk helper such that infants can lean on the mobile frame (23) with their hands to practice walking.

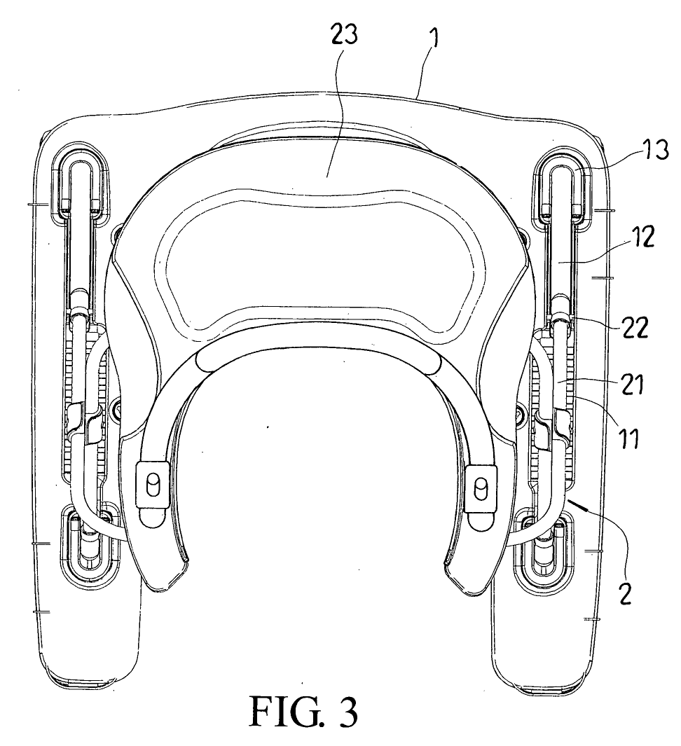

In assembling process, referring to FIGS. 1 to 3, the combining parts (22) provided at the bottom of the foldable leg unit (2) are mounted respectively in the openings (121) and pivot mount portions (111). Then the plural cover bodies (13) are fixed over the openings (121) or the pivot mount portions (111) by the interlocking between the snap hooks (132) and the snap holes (14), and by the engagement of the detent hooks (131) provided on the bottom end surface of each cover body (13) with the openings (121) or the pivot mount portions (111) in such a manner that the combining parts (22) on the bottom end of the foldable leg unit (2) can be avoided from stripping off from the openings (121) or the pivot mount portions (111). The combining parts (22) of the support rods (21) can slide along the rails (12) to adjust the height of the mobile frame (23) in response to a variety of height of infants, so that infants can lean on the mobile frame (23) to practice walking. Inasmuch as the rails are located on the top surface of the base body (1) and the combining parts (22) are located on both sides of the support rods (21), excellent stability can be achieved when the combining parts (22) of the support rods slide along the rails (12). The foldable leg unit (2) can be separated from the base body (1) by only removing all the cover bodies (13), so as to reduce the storage space.

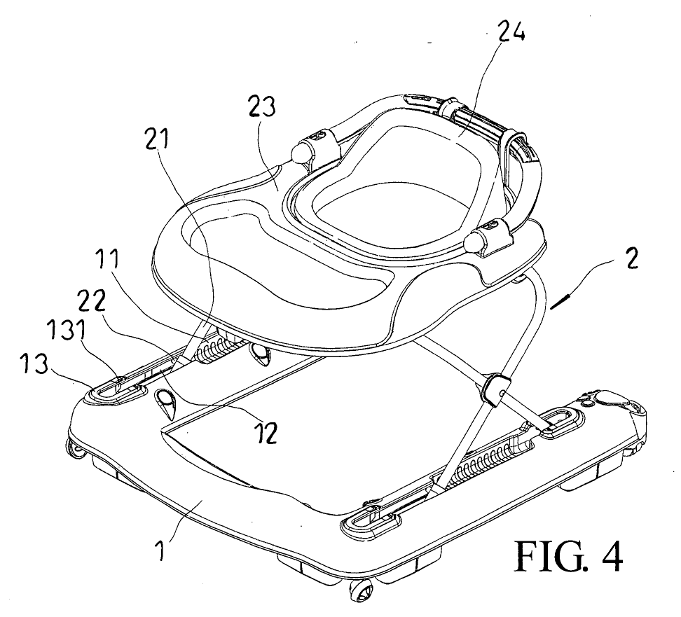

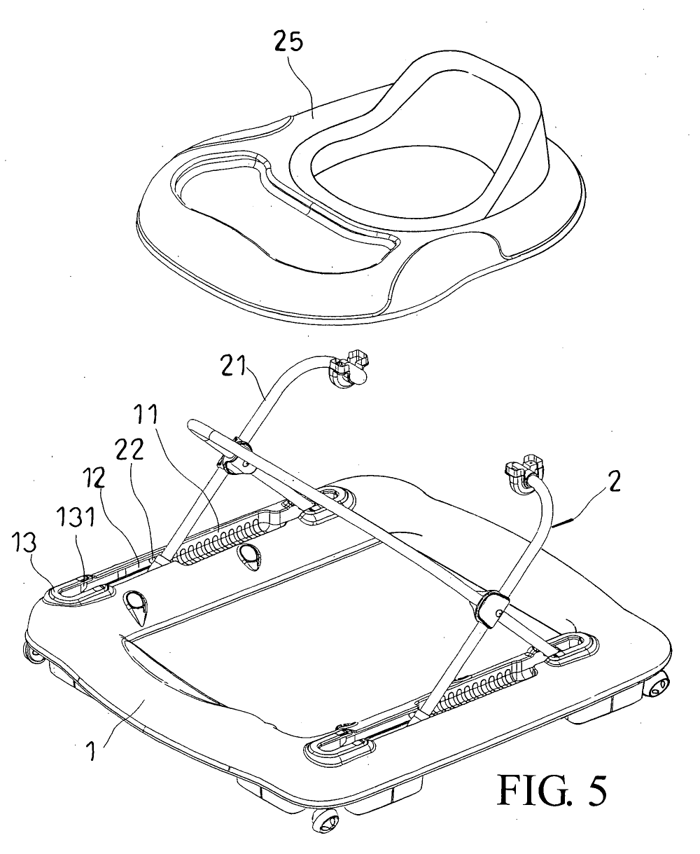

FIG. 4 is a schematic view showing the second embodiment of the base structure of baby walker of the present invention. The difference of this embodiment with the first embodiment is that a seat (24) is fixed at the rear side of the mobile frame (23) of the foldable leg unit (2) to serve as a walk helper for infants to ride thereon. Referring to FIG. 5 showing a schematic view of the third embodiment of this invention, a seat frame (25) is directly fixed on the top end of the foldable leg unit (2). However, the above embodiments or drawings concerned are not intended to restrict product aspect, fixing structure or usage. Variations or modifications conducted by the person having ordinary skill in the art without departing from the spirit and the scope of this invention are still regarded to be within the scope of this invention.

It is apparent from the above description concerning the composition of elements and the implementation, the present invention has the following advantages when comparing with prior art.

1. In this invention, rails are formed on the top surface of the base body, and combining parts are respectively provided on both sides of the support rods of the foldable leg unit. Then, the combining parts of the support rods are mounted on the rails such that excellent stability can be achieve, when the combining parts of each support rod slide along the rails.

2. In this invention, the combining parts of each support rod are mounted on the rail and then a cover body is fixed over each rail. The foldable leg unit can be separated from the base body by only removing each cover body, so as to reduce the storage space.

Summing up above, the embodiment of the present invention is surely able to reach expected effectiveness in application, and the specific structure disclosed herein is not only unprecedented in the same category of product but also not open to the public before application.

What is claimed is:

1. A base structure of baby walker, comprising a base body, both sides of which are provided with guiding grooves opposite to each other; rails are formed respectively on both sides at the front ends of the guiding grooves, and openings are respectively formed on both sides at front ends of the rails; a pivot mount portion is provided on the rear end of each guiding groove; a foldable leg unit is provided on the base body, which has two support rods pivotably connected in crossover shape; a cylindrical combining part projects outwardly on both sides at the bottom end of each support rod, the combining part of the rear support rod being disposed on the pivot mount portion, while the combining part of the front support rod being mounted on the rail from the opening.

2. A base structure of baby walker as claimed in claim 1, wherein cover bodies are provided over said openings, detent hooks being provided on said cover bodies so as to engage into said openings.

3. A base structure of baby walker as claimed in claim 2, wherein snap hooks are provided on said cover bodies, which engage with snap holes correspondingly provided on said base body.

4. A base structure of baby walker as claimed in claim 1, wherein cover bodies are provided over said pivot mount portions, detent hooks being provided on said cover bodies so as to engage into said pivot mount portions.

5. A base structure of baby walker as claimed in claim 4, wherein snap hooks are provided on said cover bodies, which engage with snap holes correspondingly provided on said base body.

6. A base structure of baby walker as claimed in claim 1, wherein a mobile frame is fixed on top end of said foldable leg unit.

7. A base structure of baby walker as claimed in claim 6, wherein a seat is assembled at rear side of said mobile frame.

8. A base structure of baby walker as claimed in claim 1, wherein a seat frame is provided on top end of said foldable leg unit.
